(19) United States
(12) Patent Application Publication
(10) Pub. No.: US 2003/0053587 A1
(43) Pub. Date: Mar. 20, 2003

(54) CT-data pick-up

(76) Inventor: Nikolaus Demharter, Dormitz (DE)

Correspondence Address: SCHIFF HARDIN & WAITE, 6600 SEARS TOWER, 233 S WACKER DR, CHICAGO, IL, 60606-6473, US

(21) Appl. No.: 10/225,043

(22) Filed: Aug. 21, 2002

(30) Foreign Application Priority Data
Aug. 21, 2001 (DE) 10140863.3

(51) Int. Cl. G21K 1/12

(52) U.S. Cl. 378/19

(57) ABSTRACT

A data pick-up for a computed tomography apparatus has a multiplexer and a number of channels that each have a radiation detector for converting X-rays into light and then into a proportional current, an integrator and an AD converter, and the digitization of the current ensues via an integrating digitization method by means of dual-slope conversion. The integrator is followed by a comparator that determines the discharge time of the integrator voltage under the influence of a defined reference charge voltage, and whereby the comparator is followed by a digitization unit.

### BACKGROUND OF THE INVENTION

1. Field of the Invention

The present invention is directed to a CT (computed tomography) data pickup of the type having a multiplexer and a number of channels that each have a radiation detector for converting the X-rays into light and then into a proportional current, an integrator and an AD converter.

2. Description of the Prior Art

The standard structure of CT data pick-of the above type ups is an analog circuit chain of a radiation detector, including photodiodes, for the conversion of the radiation into light and then into a proportional current, an integrator that integrates the photocurrent over the exposure time, a sample and hold circuit for the intermediate storage of the analog value, an analog multiplexer for connecting a plurality of analog channels onto an AD converter, and of the AD converter, which works according to the successive approximation method.

Due to the high precision demands (18-bit resolution) and small input currents in the range of a few nA, this chain of analog circuits is very susceptible to malfunction and very difficult to integrate in one component. The tolerances of the analog component parts, for example in the integrator, enter fully into the measuring precision. The demands made of the stability of the circuit are extremely high, and errors in the individual analog circuit parts contribute to produce in error that ultimately is rather large.

### SUMMARY OF THE INVENTION

An object of the present invention is to design a CT data pick-up of the type initially described wherein the number of channels can be considerably increased with enhanced measuring precision, and which can be built as a highly integrated circuit in response to the limited volume for electronic circuits.

This object is inventively achieved in CT data pick-up of the above type wherein the digitization of the current ensues via an integrating digitization method by means of dual-slope conversion, and wherein the integrator is followed by a comparator that determines the discharge time of the integrator voltage under the influence of a defined reference charge voltage, and wherein the comparator is followed by a digitization unit.

The circuit is preferably fashioned such that the output signals of the comparator are digitized via a clock frequency-controlled counter and are supplied to the multiplexer, fashioned as a digital multiplexer.

As a result of the inventive application of the dual-slop method—which is known in another context—the significant advantage is achieved that the integration constant τ=R*C does not enter into the digitization result. The complexity of the analog circuit is substantially reduced compared to known CT data pick-ups. By constructing the dual-slope analog-to-digital converter in parallel fashion, a large number of channels can be accepted in parallel in one chip, and the digital values then can be stored or multiplexed. Moreover, the occurrence of high-frequency analog signals is avoided, and the entire arrangement—given resolution of 18 bits or more—can be very easily expanded on the basis of counter width/frequency.

The inventive CT data pick-up can be designed as a quad-slope converter, wherein the input voltage is set at zero before the integration and is measured in the dual-slope method. The error voltages are thereby acquired, and the counter value is stored. This is followed by the measurement of the voltage Uₑ in the dual-slope method. The first numerical value is then subtracted from that counting result that has been acquired, as a result of which an error voltage (for example, an offset) can be eliminated. The quad-slope converter thus implements two dual-slope conversions for each measurement cycle.

In the inventive CT data pick-up the analog parts and the digital parts can be integrated, which, of course, can be fashioned as separate components, in a common ASIC.

### DESCRIPTION OF THE DRAWINGS

FIG. 1 is a schematic circuit diagram of an inventive multi-channel CT date pick-up.

FIG. 2 is an illustration of a channel of the CT data pick-up according to FIG. 1 fashioned as a dual-slope analog-to-digital converter (ADC).

### DESCRIPTION OF THE PREFERRED EMBODIMENTS

Inventively, the analog part 1 of an inventive CT data pick-up is composed of the integrator-comparator unit 2 comprising an integrator and a following comparator. The counter of the dual-slope analog-to-digital converter 3 and the following multiplexer 4 form the digital part 5. The analog part 1 and the digital part 5 can be constructed as separate components or can be integrated in a single ASIC. The number of input channels 2 is variable. The analog circuit chain is thereby reduced to the radiation receiver for converting the radiation into light and then into a proportional current and to a following A/D converter according to the integrating dual-slope method.

The radiation receiver includes a scintillator crystal and a photodiode per channel (pixel).

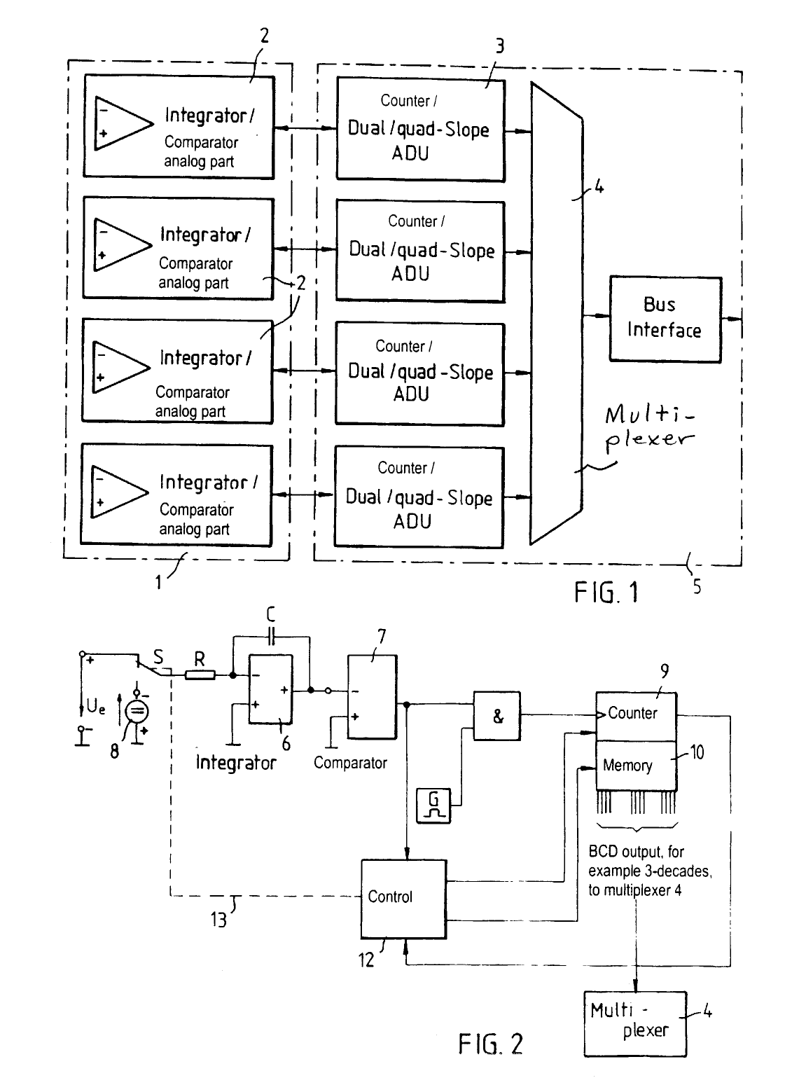

The structure of a channel of the CT data pick-up according to FIG. 1 is described in greater detail in FIG. 2. Proceeding from the input voltage U e of the photodiode of a diode array of the computed tomography installation, the current or the photocurrent is rapidly integrated with the integrator 6 via a switch S, whereby the resistor R and the capacitor C determine the integration constant. The output value of the integrator 6 is supplied to a comparator 7 wherein the integrator voltage is discharged under the influence of a defined reference discharge voltage 8—the switch S is switched over for this purpose. The significant advantage is achieved that the discharge time is independent of the integration constant τ=R*C, so that no measurement errors due to system-inherent channel-to-channel component difference can occur because of the unavoidably different integration constants in the various channels. The comparator voltage is digitized by a counter 9 with a following memory 10 that is clock frequency-controlled by means of a clock generator G. A BCD output with, for example, three decades is provided in the illustrated exemplary embodiment, this being followed by the digital multiplexer 4. Thus, no analog multiplexer that processes high-frequency analog signals need be provided—another advantage of the inventive structure. The control branch 13 departing from the control 12 toward the left to the input of the circuit indicates the possibility of expanding the dual-slope analog-to-digital converter according to FIG. 2 into a quad-slope analog-to-digital converter. As described in detail above, fault voltages, for example an offset of the input voltage Uₑ, i.e. the voltage of the photodiode, likewise can be compensated.

Although modifications and changes may be suggested by those skilled in the art, it is the intention of the inventor to embody within the patent warranted hereon all changes and modifications as reasonably and properly come within the scope of his contribution to the art.

I claim as my invention:

1. A computed tomography data pick-up comprising:
a multiplexer having a plurality of inputs respectively connected to a plurality of input channels; and
each of said input channels comprising a radiation detector for converting X-rays incident on said radiation detector into light and for converting said light into a proportional current and a unit for integrating digitization of said proportional current, comprising an integrator followed by a comparator that discharges said integrator at a discharge time dependent on a predetermined reference charge voltage, to produce an integrated signal at an output of said comparator, and a digitization unit connected to said comparator for digitizing said integrated signal according to a dual-slope conversion technique.

2. A computed tomography data pick-up as claimed in claim 1 wherein said digitization unit includes a clock frequency-controlled counter supplied with said integrated signal from said comparator, and having an output connected to said multiplexer.

3. A computed tomography data pick-up as claimed in claim 1 further comprising an arrangement for setting an input voltage of said integrator at 0 volts before beginning integration, thereby forming a quad-slope converter wherein conversion is accomplished by said dual-slope technique.

4. A computed tomography data pick-up as claimed in claim 1 wherein said integrator, said comparator and said digitization unit are integrated in common in an application specific integrated circuit.
